(19) United States
(12) Patent Application Publication
(10) Pub. No.: US 2017/0140299 A1
(43) Pub. Date: May 18, 2017

(54) DATA PROCESSING APPARATUS, DATA DISPLAY SYSTEM INCLUDING THE SAME, SAMPLE INFORMATION OBTAINING SYSTEM INCLUDING THE SAME, DATA PROCESSING METHOD, PROGRAM, AND STORAGE MEDIUM

(71) Applicant: CANON KABUSHIKI KAISHA, Tokyo (JP)

(72) Inventor: Koichi TANJI, Kawasaki-shi (JP)

(21) Appl. No.: 15/322,693

(22) PCT Filed: Jun. 30, 2015
(86) PCT No.: PCT/JP2015/003295

§ 371 Date: Dec. 28, 2016

(30) Foreign Application Priority Data
Jul. 8, 2014 (JP) 2014-140908
Apr. 30, 2015 (JP) 2015-093572

(51) Int. Cl. G06N 99/00; G01N 21/27; G01N 21/65

(52) U.S. Cl. CPC G06N 99/005; G01N 21/65; G01N 21/274; G01N 2201/06113; G01N 2201/1293

(57) ABSTRACT

A data processing apparatus that processes a spectral data item which stores, for each of a plurality of spectral components, an intensity value, includes a spectral component selecting unit and a classifier generating unit. The spectral component selecting unit is configured to select, based on a Mahalanobis distance between groups each composed of a plurality of spectral data items or a spectral shape difference between groups each composed of a plurality of spectral data items, a plurality of machine-learning spectral components from among the plurality of spectral components of the plurality of spectral data items. The classifier generating unit is configured to perform machine learning by using the plurality of machine-learning spectral components selected by the spectral component selecting unit and generate a classifier that classifies a spectral data item.

### TECHNICAL FIELD

The present invention relates generally to a data processing apparatus that processes a spectral data item, a sample information obtaining system including the same, and a data processing method.

### BACKGROUND ART

The distribution of constituents in a sample such as a biological sample is visualized by observing the target sample with a microscope, for example. Examples of the method for such visualization include mass spectrometry imaging based on mass spectrometry and spectroscopic imaging based on spectroscopy such as Raman spectroscopy. According to these methods, a plurality of measuring points are set in a target sample, and spectral data items are obtained from the respective measuring points. The spectral data items are analyzed on a measuring point basis, and the individual spectral data items are attributed with corresponding constituents in the sample. In this way, information concerning the distribution of constituents in the sample can be obtained.

Examples of the method for analyzing spectral data items and attributing the individual spectral data items with corresponding constituents in a sample include a method using machine learning. “Machine learning” is a technique for interpreting obtained new data by using a learning result such as a classifier which is obtained by learning previously obtained data.

PTL 1 describes a technique for generating a classifier by machine learning and then applying the classifier to a spectral data item obtained from a sample. Note that the term “classifier” used herein refers to criterion information that is generated by learning relationships between previously obtained data and information such as biological information corresponding to the previously obtained data.

In the related art, all spectral components of a spectral data item are used in processing when the spectral data item is analyzed using machine learning. Such a configuration, however, has issues in that a vast amount of data has to be processed and the processing time undesirably increases in the case where a single spectral data item includes many spectral components or many spectral data items are analyzed.

The processing can be made quicker by randomly selecting spectral components and thereby reducing the number of spectral components per spectral data item and eventually the amount of data. However, information necessary for analysis may be lost by random selection of spectral components. The loss of such information undesirably leads to a decreased classification accuracy of the classifier which is generated by machine learning.

### CITATION LIST

### Patent Literature

PTL 1: Japanese Patent Laid-Open No. 2010-71953

### SUMMARY OF INVENTION

### Solution to Problem

An aspect of the present invention provides a data processing apparatus that processes a spectral data item which stores, for each of a plurality of spectral components, an intensity value. The data processing apparatus includes a spectral component selecting unit configured to select, based on a Mahalanobis distance between groups each composed of a plurality of spectral data items or a spectral shape difference between groups each composed of a plurality of spectral data items, a plurality of machine-learning spectral components from among the plurality of spectral components of the plurality of spectral data items; and a classifier generating unit configured to perform machine learning by using the plurality of machine-learning spectral components selected by the spectral component selecting unit and generate a classifier that classifies a spectral data item.

Further features of the present invention will become apparent from the following description of exemplary embodiments with reference to the attached drawings.

### BRIEF DESCRIPTION OF DRAWINGS

FIG. 1 is a diagram schematically illustrating a configuration of a sample information obtaining system according to an embodiment.

FIG. 2 is a flowchart illustrating an operation of a data processing apparatus according to the embodiment.

FIG. 3A is a conceptual diagram illustrating a spectral data item.

FIG. 3B is a conceptual diagram illustrating a spectral data item.

FIG. 3C is a conceptual diagram illustrating a spectral data item.

FIG. 4A is a conceptual diagram illustrating a method for deciding upon sampling intervals by using a rate of change in the spectral distribution.

FIG. 4B is a conceptual diagram illustrating a method for deciding upon sampling intervals by using a rate of change in the spectral distribution.

FIG. 5A is a conceptual diagram illustrating a between-group variance.

FIG. 5B is a conceptual diagram illustrating a within-group variance.

FIG. 6A is a diagram schematically illustrating a method for selecting machine-learning spectral components by using the Mahalanobis distance.

FIG. 6B is a diagram schematically illustrating a method for selecting machine-learning spectral components by using the Mahalanobis distance.

FIG. 7 is a diagram schematically illustrating a process of selecting machine-learning spectral components on the basis of a data set obtained by measurement in advance and of obtaining a new machine-learning data set by performing measurement for the selected machine-learning spectral components.

FIG. 8 is a diagram illustrating spectroscopic image data and spectral data items for respective constituents used in a first example.

FIG. 9A is a diagram illustrating the Mahalanobis distance according to the first example.

FIG. 9B is a diagram in which spectral data items are plotted with respect to machine-learning spectral components selected based on the Mahalanobis distance according to the first example.

FIG. 9C is a diagram illustrating the Mahalanobis distance according to the first example.

FIG. 9D is a diagram in which spectral data items are plotted with respect to machine-learning spectral components selected based on the Mahalanobis distance according to the first example.

FIG. 10A is a diagram in which spectral data items are plotted with respect to machine-learning spectral components selected in the first example.

FIG. 10B is a diagram in which spectral data items are plotted with respect to machine-learning spectral components selected in the first example.

FIG. 11A illustrates an image reconstruction result according to the first example.

FIG. 11B illustrates an image reconstruction result according to a comparative example.

FIG. 12A is a diagram schematically illustrating an averaging process according to the embodiment.

FIG. 12B is a diagram schematically illustrating an averaging process according to the embodiment.

FIG. 12C is a diagram schematically illustrating an averaging process according to the embodiment.

FIG. 13 is a diagram in which spectral data items are plotted with respect to machine-learning spectral components selected in a second example.

FIG. 14A illustrates an image reconstruction result according to the second example.

FIG. 14B illustrates an image reconstruction result according to the first example.

### DESCRIPTION OF EMBODIMENTS

Embodiments for carrying out the present invention will be specifically described with reference to the attached drawings. Note that specific exemplary embodiments described below are merely desirable exemplary embodiments of the present invention, and the present invention is not limited to these specific exemplary embodiments.

### Configuration

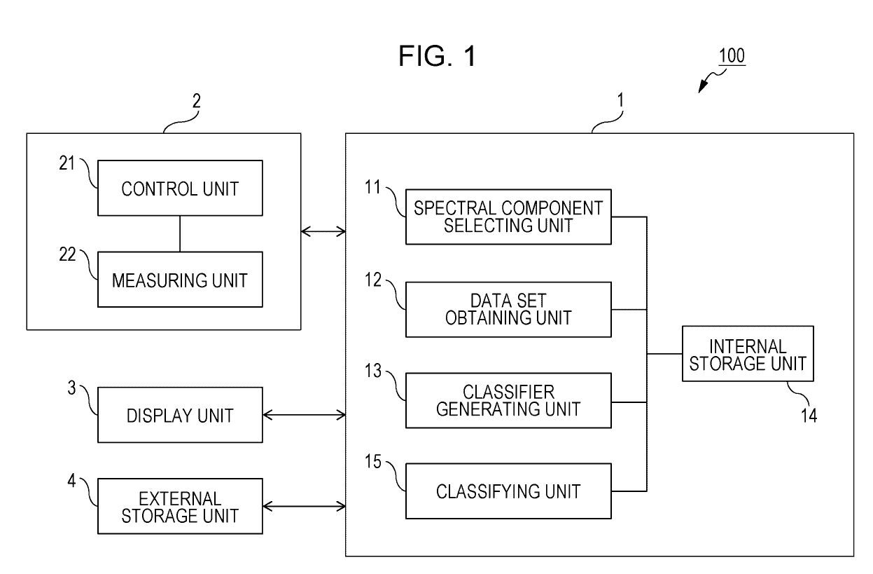

Firstly, a configuration of a data processing apparatus 1 (hereinafter, simply referred to as the “apparatus 1”) according to an embodiment will be described with reference to FIG. 1. FIG. 1 is a block diagram illustrating a configuration of a sample information obtaining system 100 including the apparatus 1 according to the embodiment.

The sample information obtaining system 100 (hereinafter, simply referred to as the “system 100”) according to the embodiment includes the apparatus 1, a measuring apparatus 2, a display unit 3, and an external storage unit 4. All or some of the apparatus 1, the measuring apparatus 2, the display unit 3, and the external storage unit 4 may be connected to one another via a network. Examples of the network include a local area network (LAN) and the Internet.

The measuring apparatus 2 includes a measuring unit 22 and a control unit 21. The measuring unit 22 is controlled by the control unit 21. The measuring unit 22 measures a spectrum from a sample (not illustrated) and obtains a spectral data item.

The spectral data item is not limited to any particular type and may be any data that stores, for each of a plurality of spectral components, an intensity value (hereinafter, referred to as a “spectral intensity”) of the spectral component. For example, data that stores, for each measurement parameter (corresponding to the spectral component), a response intensity (corresponding to the spectral intensity) of a response which occurs when a stimulus is given to a sample is usable as the spectral data item. Examples of the “stimulus” used herein include an electromagnetic wave, sound, an electromagnetic field, temperature, and humidity.

Specifically, examples of the spectral data item include a spectral data item obtained by ultraviolet, visible, or infrared spectroscopy; a spectral data item obtained by Raman spectroscopy; a nuclear magnetic resonance (NMR) spectral data item; a mass spectral data item; a liquid chromatogram; a gas chromatogram; and a sound frequency spectral data item. Types of the spectral data item obtained by Raman spectroscopy include a spectral data item obtained by spectroscopy based on spontaneous Raman scattering and a spectral data item obtained by spectroscopy based on non-linear Raman scattering. Examples of spectroscopy based on non-linear Raman scattering include stimulated Raman scattering (SRS) spectroscopy, coherent anti-stokes Raman scattering (CARS) spectroscopy, and coherent stokes Raman scattering (CSRS) spectroscopy. Desirably, the spectral data items are spectral data items including any one of spectral data items obtained by ultraviolet, visible, or infrared spectroscopy; spectral data items obtained by Raman spectroscopy; and mass spectral data items.

In the case where the spectral data item is a spectral data item obtained by ultraviolet, visible, or infrared spectroscopy or by Raman spectroscopy, the wavelength or the wave number can serve as spectral components of the spectral data item. In the case where the spectral data item is a mass spectral data item, the mass-to-charge ratio or the mass number can serve as spectral components of the spectral data item.

Each spectral data item belongs to a corresponding one of groups (categories), each of which corresponds to a corresponding one of a plurality of constituents in a sample. Spectral components and their spectral intensities differ depending on the constituent of the sample located at a measuring area where the spectral data item is obtained. Accordingly, analyzing spectral data items makes it possible to identify a group to which each spectral data item belongs and to attribute the spectral data item with a corresponding constituent.

The display unit 3 displays a processing result obtained by the apparatus 1. For example, an image display device such as a flat panel display is usable as the display unit 3. The display unit 3 is capable of displaying, for example, image data sent from the apparatus 1.

The external storage unit 4 is a device that stores various kinds of data. The external storage unit 4 is capable of storing spectral data items obtained by the measuring apparatus 2 and various kinds of data, such as a classifier generated by a classifier generating unit 13 (described later), for example. The external storage unit 4 may store a processing result obtained by the apparatus 1.

The various kinds of data stored in the external storage unit 4 can be read and displayed on the display unit 3 as needed. In addition, the apparatus 1 may perform processing by using the classifier and the spectral data items stored in the external storage unit 4. Furthermore, spectral data items generated by another apparatus through measurement may be pre-stored in the external storage unit 4, and the apparatus 1 may process the spectral data items.

The apparatus 1 processes spectral data items by using machine learning. The apparatus 1 includes a spectral component selecting unit 11, a data set obtaining unit 12, the classifier generating unit 13, an internal storage unit 14, and a classifying unit 15.

The spectral component selecting unit 11 (hereinafter, simply referred to as the “selecting unit 11”) selects a plurality of spectral components used in machine learning performed by the classifier generating unit 13 (described later), from among a plurality of spectral components included in each spectral data item. Hereinafter, spectral components used in machine learning are referred to as machine-learning spectral components.

The data set obtaining unit 12 (hereinafter, simply referred to as the “obtaining unit 12”) obtains a plurality of spectral data items used in machine learning, each composed of the machine-learning spectral components selected by the selecting unit 11. Hereinafter, a spectral data item used in machine learning is referred to as a machine-learning spectral data item, and a data set including a plurality of machine-learning spectral data items is referred to as a machine-learning data set. As described later, the obtaining unit 12 is capable of obtaining a machine-learning data set by extracting the machine-learning spectral components from the plurality of spectral data items stored in the external storage unit 4 or the internal storage unit 14. Alternatively, the obtaining unit 12 may obtain a machine-learning spectral data set by performing measurement with the measuring apparatus 2, for the machine-learning spectral components selected by the selecting unit 11.

A machine-learning spectral data item has a smaller amount of data than the original spectral data item. Specifically, an amount of data per spectral data item can be reduced by M/N, where N denotes the total number of spectral components included in the original spectral data item and M denotes the number of machine-learning spectral components selected by the selecting unit 11. Accordingly, the classifier generating unit 13 (described later) can perform a machine learning process more quickly, which can consequently reduce the time taken for generation of a classifier.

The classifier generating unit 13 (hereinafter, simply referred to as the “generating unit 13”) performs machine learning by using the machine-learning data set obtained by the obtaining unit 12 and generates a classifier that classifies a spectral data item. Specifically, the generating unit 13 performs machine learning by using the plurality of machine-learning spectral components selected by the selecting unit 11 and generates a classifier that classifies a spectral data item.

In this embodiment, the obtaining unit 12 desirably obtains, for each machine-learning spectral data item included in the machine-learning data set, information (i.e., so-called label information) concerning a constituent to which the machine-learning spectral data item belongs, along with the machine-learning data set. The generating unit 13 performs machine learning by using the machine-learning data set attached with the label information. That is, the generating unit 13 performs supervised machine learning to generate a classifier.

The internal storage unit 14 stores spectral data items obtained by the measuring apparatus 2 and various kinds of data generated by the selecting unit 11, the obtaining unit 12, the generating unit 13, and the classifying unit 15.

The classifying unit 15 classifies, by using the classifier generated by the generating unit 13, a new spectral data item that is obtained from the measuring apparatus 2, the external storage unit 4, or the internal storage unit 14 and that is yet to be classified. The classifying unit 15 is capable of classifying a spectral data item by using the classifier and attributing the spectral data item with a corresponding constituent in a sample.

### Operation

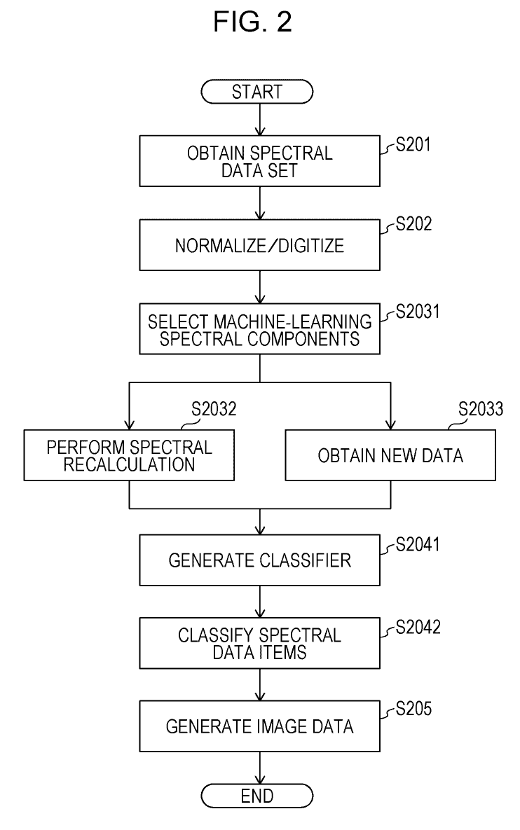

Now, how the system 100 including the apparatus 1 according to the embodiment operates will be described with reference to FIGS. 2 to 7.

FIG. 2 is a flowchart illustrating an operation of the apparatus 1 according to the embodiment. A description will be given below according to this flowchart with reference to other drawings as needed.

In this embodiment, the apparatus 1 firstly obtains a data set including a plurality of spectral data items from the measuring apparatus 2 or the external storage unit 4 (S201).

If a space in which spectral data items are obtained is a two-dimensional plane (X-Y plane), the data set obtained by the apparatus 1 is data which stores spectral data items in association with corresponding pixels on the X-Y plane. That is, the date set obtained by the apparatus 1 is a four-dimensional data set represented as (X, Y, A, B), in which a spectral component of each spectral data item and the spectral intensity of the spectral component (A, B) are stored in association with a corresponding pixel represented by positional information (X, Y) of the measuring point on the two-dimensional plane where the spectral data item is obtained.

The dimension of the data set processed by the apparatus 1 according to the embodiment is not limited to this particular example. In addition to the data set described above, the apparatus 1 is also capable of processing a data set of spectral data items obtained in a three-dimensional space, for example. That is, the data set processed by the apparatus 1 may be a five-dimensional data set represented as (X, Y, Z, A, B), in which each spectral data item (A, B) is stored in association with a corresponding pixel represented by positional information (X, Y, Z) in the three-dimensional space.

Processing of a four-dimensional data set obtained by measuring spectra on the two-dimensional plane will be described in detail below in order to simply the explanation; however, a five-dimensional data set which further includes Z-direction information can be processed in the similar manner.

Then, the apparatus 1 normalizes and digitizes the obtained data set (S202). Any available processing method may be used in this normalization and digitization process.

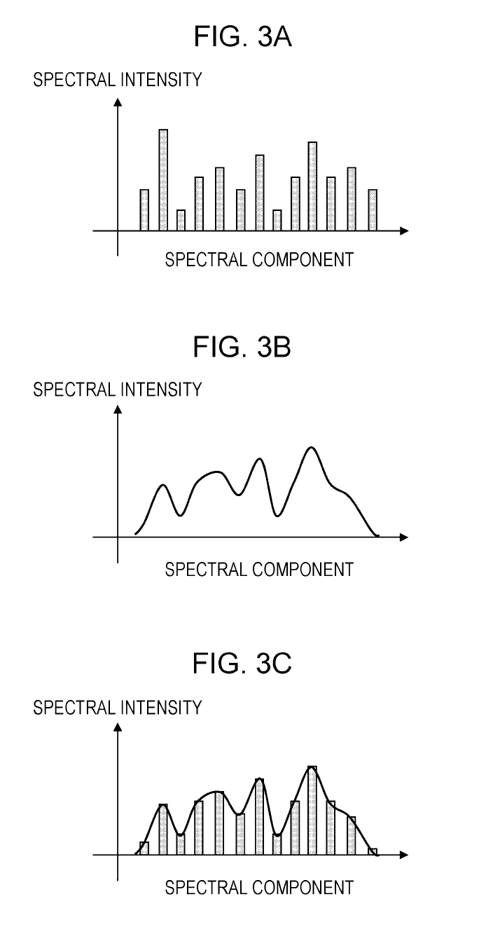

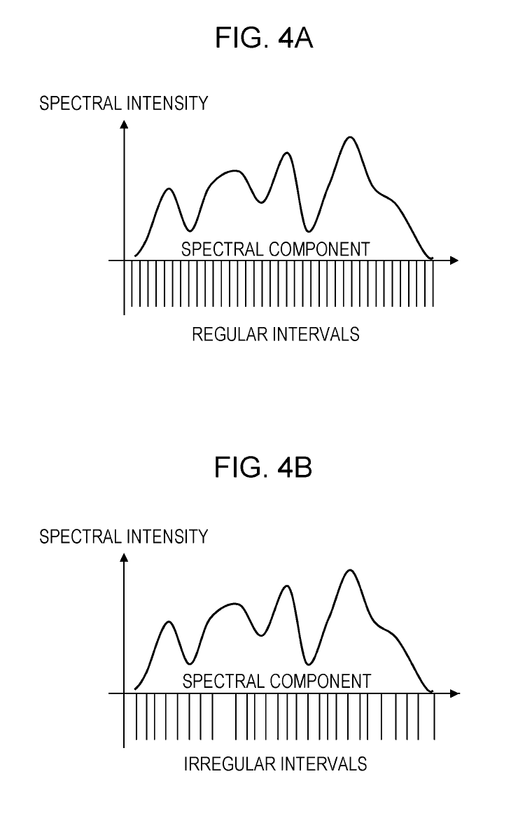

In the case where a spectroscopic spectral data item such as a spectral data item obtained by Raman spectroscopy is used as the spectral data item, the spectral data item is often continuous as illustrated in FIG. 3B. In this case, such a spectral data item is desirably discretized, and the resulting discrete spectral data item illustrated in FIG. 3C is desirably used. Obtaining a discrete spectral data item by performing extraction on a spectral data item at regular intervals (FIG. 4A) or irregular intervals (FIG. 4B) in this manner is referred to as “sampling”.

In the case where a discrete spectral data item illustrated in FIG. 3A, for example, a mass spectral data item obtained by mass spectrometry, is used as the spectral data item, such a spectral data item may be used without any processing. Alternatively, sampling may be performed on the spectral data item also in the case of using a discrete spectral data item such as the one illustrated in FIG. 3A.

In the case of performing sampling, sampling is desirably performed at sampling intervals based on a rate of change in the spectral shape of the spectral data item. Specifically, as illustrated in FIG. 4B, the sampling intervals are desirably decided upon such that sampling is performed finely at a part where the rate of change in the spectral shape is large and coarsely at a part where the rate of change in the spectral shape is small.

The sampling intervals are decided upon based on the rate of change in the spectral shape in this manner, and sampling is performed at the sampling intervals. Such a configuration enables the spectral data item to be discretized to have a decreased number of spectral components while maintaining the shape of the spectral data item to some degree. The term “spectral shape” used herein refers to the shape of a graph obtained when the spectral intensity is expressed as a function of the spectral component. Accordingly, the rate of change in the spectral shape can be quantitatively handled as the second derivative which is obtained by differentiating the derivative of such a function with respect to the spectral component.

In the case where the rate of change in the spectral shape differs greatly from a constituent to another, the rate of change in the spectral shape may be computed separately for the individual constituents. Then, spectral components may be selected separately in accordance with the rate of change for each spectral data item, and all the spectral components selected for the spectral data items are put together. In this way, the sampling intervals may be decided upon.

### Step of Selecting Machine-Learning Spectral Components

Then, the selecting unit 11 selects machine-learning spectral components used by the generating unit 13 in machine learning, from the obtained data set (S2031). The use of machine-learning spectral components selected in this step for generation of a classifier can reduce the time taken for generation of a classifier. Although the time taken for generation of a classifier can be reduced by randomly selecting machine-learning spectral components, random selection undesirably decreases the classification accuracy of the resulting classifier.

Accordingly, machine-learning spectral components are selected according to (1) a method using the Mahalanobis distance and (2) a method using a difference in the spectral shape in the step of selecting spectral components according to this embodiment. These methods will be described below.

(1) Method using Mahalanobis Distance

The Mahalanobis distance is defined as a ratio of a between-group variance to a within-group variance (between-group variance/within-group variance) of a group of interest in the case where a plurality of spectral data items which belong to respective groups corresponding to constituents in a sample are projected onto a feature space on a spectral component basis.

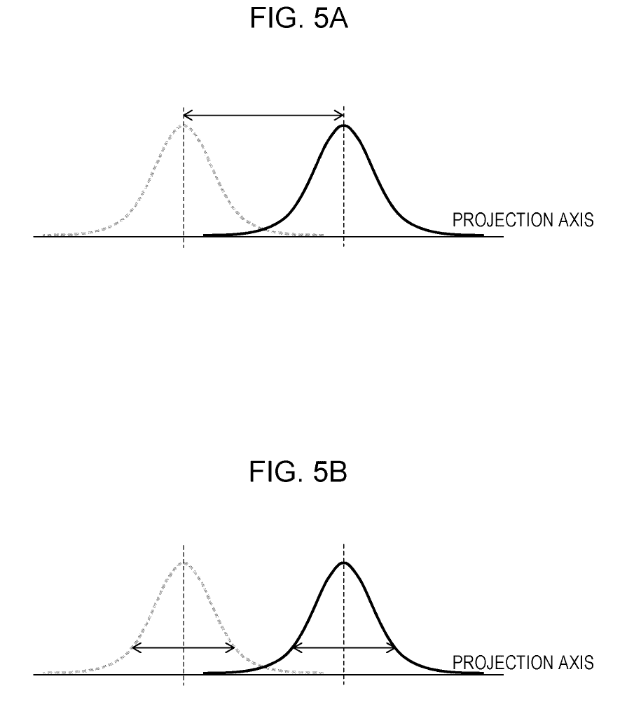

A within-group variance can be obtained by computing, for each of the plurality of groups, a variance within the group as illustrated in FIG. 5B. At this time, the within-group variance is computed by projecting a plurality of spectral data items included in each group on a spectral component basis by using the spectral intensity as the projection axis. A between-group variance can be obtained by determining the center of mass of each of the plurality of groups on the projection result and computing a distance between the centers of mass of groups as illustrated in FIG. 5A.

The larger the between-group variance, the larger the distance between the groups. Accordingly, the groups are more distinguishable from each other. The smaller the within-group variance, the smaller the overlap of the groups. Accordingly, the groups are more distinguishable from each other. That is, spectral data components having a larger Mahalanobis distance, which is defined as “between-group distance/within-group distance”, enable more efficient separation and classification of spectral data items in machine learning. Accordingly, by selecting spectral components having a large Mahalanobis distance and performing machine learning using the selected spectral components, a classifier having the maintained classification accuracy can be generated more quickly than in the related art.

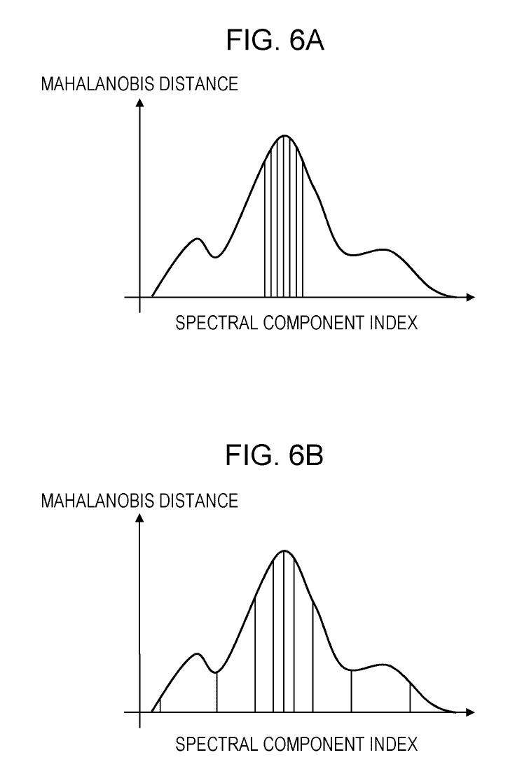

Example of the method for selecting machine-learning spectral components on the basis of the Mahalanobis distance include a method for selecting spectral components in order of decreasing Mahalanobis distance as illustrated in FIG. 6A. This method allows selection of spectral components which are expected to allow efficient classification. There may be a case where three or more groups are to be distinguished and spectral components having a large Mahalanobis distance differ from a pair of groups selected from the three or more groups to another pair. In such a case, a given number of spectral components are selected in order of decreasing Mahalanobis distance for each pair of groups, and the spectral components selected for the pairs of groups are put together. In this way, the machine-learning spectral components may be selected.

Alternatively, machine-learning spectral components may be selected from among all spectral components such that the machine-learning spectral components are selected finely at a part where the Mahalanobis distance is large and coarsely at a part where the Mahalanobis distance is small as illustrated in FIG. 6A. Spectral components suitable for classification may exist among spectral components having a small Mahalanobis distance. Accordingly, this method may make the machine-learning-based classification accuracy higher than the method of selecting spectral components in order of decreasing Mahalanobis distance. As a result, a classifier having a higher classification accuracy may be generated.

The method using the Mahalanobis distance to select machine-learning spectral components allows selection of spectral components that enable efficient separation and classification of spectral data items even if the spectral data items belonging to different groups have similar spectral shapes. For example, in the case of spectroscopic spectral data items obtained from a biological sample, spectral data items having similar spectral shapes may be obtained for each constituent. In such a case, machine-learning spectral components are desirably selected based on the Mahalanobis distance. In addition, the method for selecting machine-learning spectral components by using the Mahalanobis distance can be used also in the case where spectral data items belonging to different groups have different spectral shapes.

### (2) Method Using Difference in Spectral Shape

In the case where spectral data items belonging to different groups have greatly different spectral shapes, machine-learning spectral components can be selected based on the difference in the spectral shape. For example, in the case where only a specific group among a plurality of groups has a certain spectral component with a large spectral intensity, such a spectral component may be a spectral component for a substance unique to a constituent of a sample that corresponds to the specific group. Selection of such a spectral component as a machine-learning spectral component can make generation of a classifier quicker than in the related art, while maintaining the classification accuracy. That is, spectral components suitable for machine-learning-based classification can be selected by selecting, as machine-learning spectral components, spectral components whose spectral shapes greatly differ from one another.

The method using the Mahalanobis distance and the method using a difference in the spectral shape may be used together to select machine-learning spectral components. In this step (S2031), the selecting unit 11 may read specific spectral components pre-stored in the external storage unit 4 or the internal storage unit 14 and select the specific spectral components as machine-learning spectral components. That is, suitable machine-learning spectral components may be decided upon and accumulated in advance for each constituent or tissue of a sample subjected to machine-learning-based classification, and the suitable accumulated spectral components are read. Such a configuration can make selection of machine-learning spectral components quicker.

### Step of Obtaining Machine-Learning Data Set

Then, the obtaining unit 12 obtains a machine-learning data set which includes a plurality of machine-learning spectral data items each composed of the machine-learning spectral components selected in step S2031.

At this time, the obtaining unit 12 may obtain the machine-learning data set by extracting the machine-learning spectral components from spectral data items included in an already obtained data set and thereby obtaining machine-learning spectral data items (S3032).

Alternatively, the obtaining unit 12 may obtain the machine-learning data set by performing measurement with the measuring apparatus 2 for the machine-learning spectral components selected in step S2031 and thereby obtaining a plurality of machine-learning spectral data items (S2033). That is, the obtaining unit 12 may obtain new machine-learning spectral data items by performing measurement with the measuring apparatus 2 for the selected machine-learning spectral components.

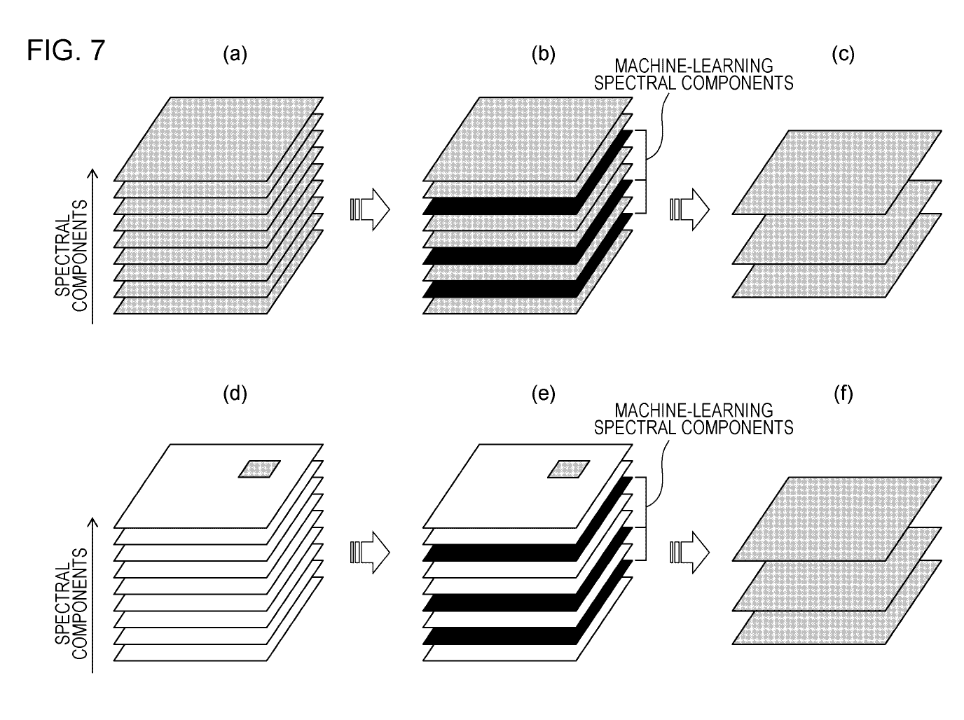

FIG. 7 is a diagram schematically illustrating a process of selecting machine-learning spectral components on the basis of a data set resulting from previous measurement and of obtaining a new machine-learning data set by performing measurement for the selected machine-learning spectral components.

In the case illustrated in parts (a) to (c) of FIG. 7, firstly, a data set is obtained by performing measurement with the measuring apparatus 2 across the entire region for all spectral components (part (a) of FIG. 7). Then, the selecting unit 11 selects machine-learning spectral components on the basis of spectral data items included in the obtained data set (part (b) of FIG. 7). Then, the obtaining unit 12 performs measurement with the measuring apparatus 2 across the entire region for the selected machine-learning spectral components and obtains a machine-learning data set (part (c) of FIG. 7).

In the case illustrated in parts (d) to (f) of FIG. 7, firstly, a data set is obtained by performing measurement with the measuring apparatus 2 at a partial region for all spectral components (part (d) of FIG. 7). Then, the selecting unit 11 selects machine-learning spectral components on the basis of spectral data items included in the obtained data set (part (e) of FIG. 7). Then, the obtaining unit 12 performs measurement with the measuring apparatus 2 across the entire region for the selected machine-learning spectral components and obtains a machine-learning data set (part (f) of FIG. 7). Performing measurement at a limited partial region in advance can reduce the time taken for measurement.

An averaging process may be performed on the machine-learning data set before machine-learning is performed using the machine-learning data set. The averaging process is desirably performed on a spectral component basis. When the averaging process is performed on a spectral component basis, the spectral component averaging process is desirably performed on a group basis in accordance with the magnitude of the within-group variance of the group to be distinguished.

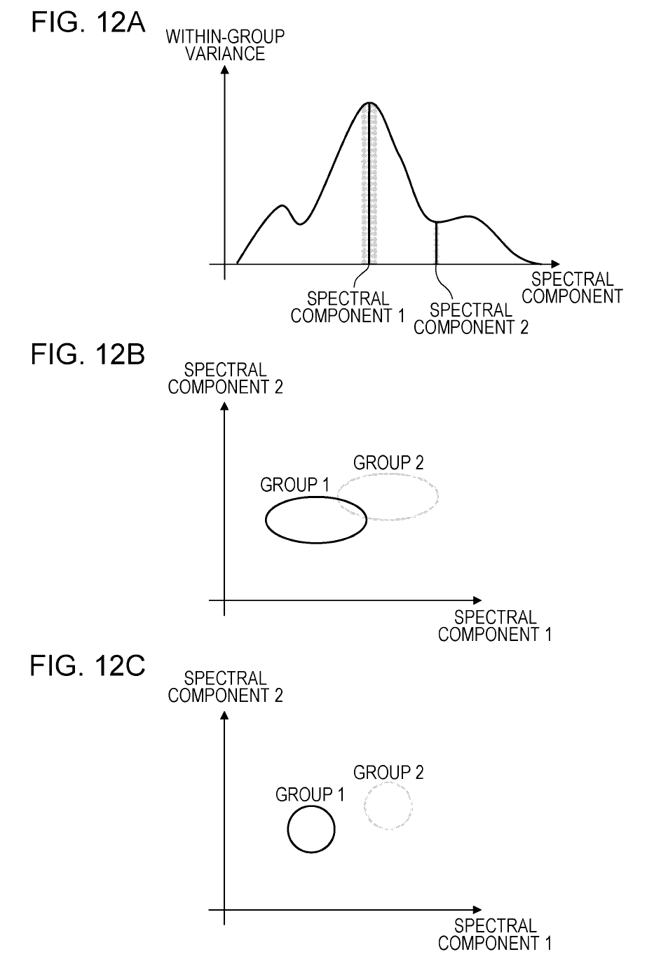

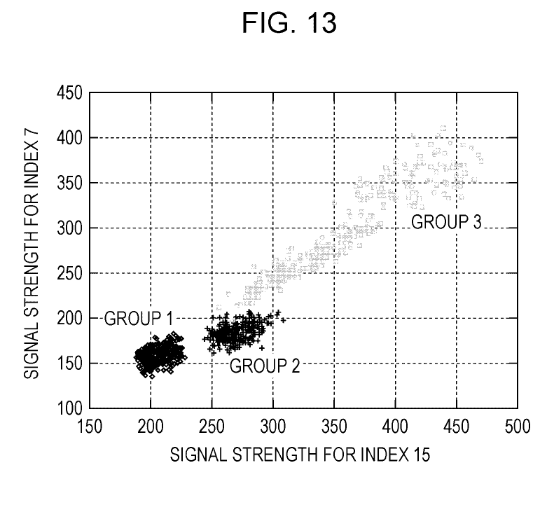

For example, as illustrated in FIG. 12A, the recomputed within-group variance of the spectral component can be made smaller by determining an average of a spectral component 1 having a large within-group variance and its adjacent spectral components located in a range wider than a range for a spectral component 2. Referring to FIG. 12A, a gray portion indicates a range for which the averaging process is performed. The averaging process typically involves a decrease in the resolution of the spectral component. For this reason, it is not desirable to perform the averaging process on a spectral component having a small within-group variance over a wide range. However, such an unnecessary decrease in the resolution can be suppressed, for example, by increasing the range of the averaging process in proportion to the magnitude of the within-group variance as described above. This configuration can consequently increase the Mahalanobis distance between groups to be distinguished (FIG. 12C) and can lead to an improved classification accuracy.

In the averaging process, a spectral component having a large within-group variance may be selected, and spectral intensities of the selected spectral component may be averaged on a group basis. For example, in the case where the spectral component 1 has a large within-group variance as illustrated in FIG. 12B, averaging spectral intensities of the spectral component 1 makes separation of and distinction between groups easier as illustrated in FIG. 12C.

### Step of Generating Classifier

Then, the generating unit 13 performs machine learning by using the machine-learning data set obtained in step S2032 or S2033 and generates a classifier (S2041). Desirably, supervised machine learning is performed in this embodiment. Specifically, a technique such as the Fisher linear discriminant analysis, the support vector machine (SVM), the decision tree learning, or the random forest based on the ensemble average is usable. Note that machine learning performed in this embodiment is not limited to such a technique and may be unsupervised machine learning or semi-supervised machine learning.

In this step, spectral components and spectral intensities (referred to as “feature values”) included in the machine-learning data set are projected onto a multi-dimensional space (referred to as a “feature space”), and a classifier which is criterion information is generated by using any of the aforementioned various machine learning techniques.

At this time, the generating unit 13 generates a classifier by performing a computing process using the machine-learning data set. Accordingly, if the amount of data of the machine-learning data set processed by the generating unit 13 is large, generation of the classifier takes time. For example, the Fisher linear discriminant analysis involves computation of a sample variance-covariance matrix having a size of a product of the number of machine-learning spectral data items and the number of machine-learning spectral components of each of the machine-learning spectral data items. Accordingly, if there are many machine-learning spectral data items or many machine-learning spectral components, generation of a classifier takes a vast amount of time.

In the apparatus 1 according to this embodiment, however, the selecting unit 11 selects machine-learning spectral components, and the generating unit 13 generates a classifier by using the machine-learning spectral components. This configuration can reduce the number of machine-learning spectral components and greatly reduce the amount of computation performed by the generating unit 13, and consequently can reduce the time taken for generation of a classifier. In addition, the selecting unit 11 according to the embodiment selects machine-learning spectral components in the above-described manner. Such a configuration can reduce the time taken for generation of a classifier while maintaining the classification accuracy which results from machine learning performed by the generating unit 13.

### Step of Classifying Spectral Data Item

Then, the classifying unit 15 classifies spectral data items by using the classifier generated by the generating unit 13 (S2042). The classifying unit 15 classifies spectral data items and attributes the individual spectral data items with the respective constituents in the sample.

The spectral data items to be classified may be new spectral data items obtained by performing measurement with the measuring apparatus 2 or spectral data items that have been obtained in advance and are stored in the external storage unit 4 or the internal storage unit 14. Spectral components included in the spectral data items to be classified are not limited to any particular components but the spectral data items desirably include the machine-learning spectral components selected by the selecting unit 11.

A form of the classification result obtained by the classifying unit 15 is not limited to any particular type. For example, in the case where the apparatus 1 processes image data that stores spectral data items in association with corresponding pixels, the classifying unit 15 attributes the individual spectral data items stored in association with the corresponding pixels with corresponding constituents and attaches label data to the individual spectral data items. Then, based on the label data, the classifying unit 15 may generate two-dimensional or three-dimensional image data for displaying pixels, for which the respective spectral data items are stored, by using different colors for different constituents (S205). An image based on the generated two-dimensional or three-dimensional image data may be displayed on the display unit 3. The above-described process enables visualization of the distribution of constituents in a sample.

### OTHER EMBODIMENTS

While the exemplary embodiment of the present invention has been described above, the present invention is not limited to such an exemplary embodiment and can be variously modified and altered within the scope thereof.

For example, the present invention can be embodied as a system, an apparatus, a method, a program, or a storage medium. In the embodiment, the present invention is applied to a sample information obtaining system including the apparatus 1, the measuring apparatus 2, and the display unit 3; however, the present invention may be applied to a system including a combination of a plurality of devices or an apparatus including a single device. For example, the present invention may be applied to a data display system including the apparatus 1 according to the embodiment of the present invention and the display unit 3 that displays a processing result obtained by the apparatus 1.

In the system including a combination of a plurality of devices to which the present invention is applied, all or some of the devices may be connected to a network including the Internet. For example, obtained data may be sent to a server connected to the system via the network. Then, the server may perform the process according to the embodiment of the present invention. Then, the system may receive the result from the server and display an image or the like.

### First Example

A first example to which the embodiment of the present invention is applied will be described below. In the first example described below, measurement was performed on mouse liver tissue by using stimulated Raman scattering microscopy. The power of a Ti-sapphire (TiS) laser used as a light source was 111 mW, and the power of an Yb fiber laser was 127 mW before the beam was incident on the objective. A thin-sliced section of the formalin-fixed mouse liver tissue was used, the section having a thickness of 100 μm. The measurement was performed on such a tissue section embedded in glass with phosphate buffered saline (PBS) buffer. The measurement range was 160 micrometers square. The range of the wave number used in the measurement was set to 2800 cm⁻¹ to 3100 cm⁻¹, and the measurement was performed such that the range of the wave number was equally divided into 91 steps. The measurement was performed 10 times, and obtained measurement data items were added up. The measurement took 30 seconds.

Obtained spectroscopic image data was image data of 500×500 pixels. Note that the obtained spectroscopic image data stores, for each measured pixel, XY coordinate information (X, Y) which is position information of the measured pixel and a spectral data item (A, B) for the measured pixel.

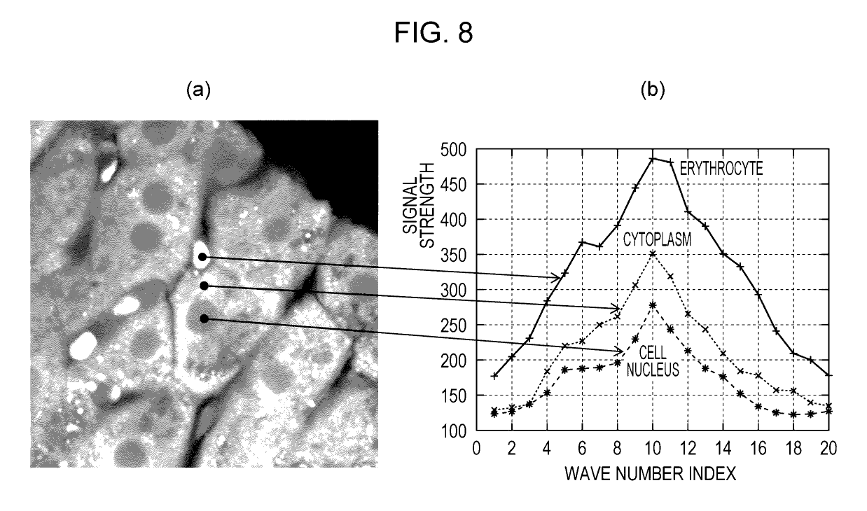

Part (a) of FIG. 8 illustrates a visualized image resulting from the addition of signals of spectral data items obtained for all spectral components used in the measurement. Part (b) of FIG. 8 illustrates a graph obtained by selecting spectral data items obtained at parts in the sample which correspond to the cell nucleus, the cytoplasm, and the erythrocyte. The horizontal axis denotes the wave number, whereas the vertical axis denotes the spectral intensity (signal strength). The value of the horizontal axis in part (b) of FIG. 8 denotes the index for distinguishing the wave number, and this index will be used in the following description. Part (b) of FIG. 8 indicates that spectral data items which are slightly different for different constituents were obtained.

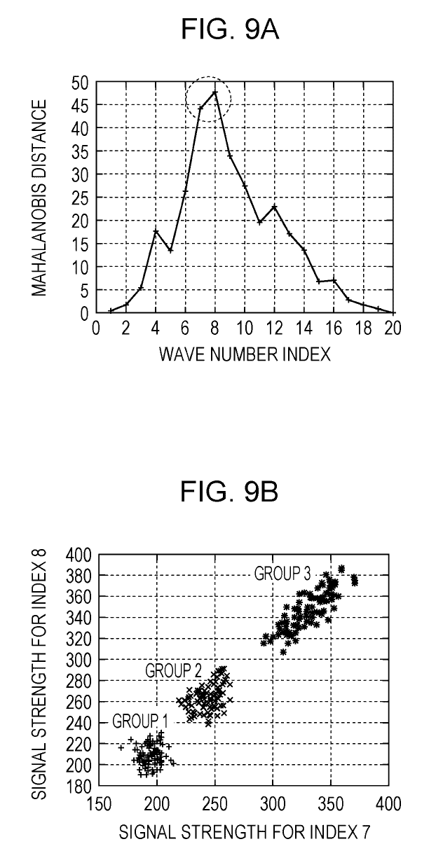

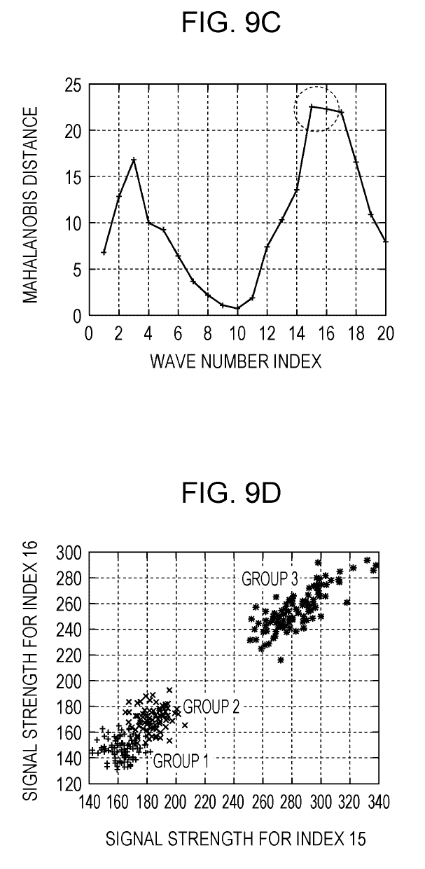

FIG. 9A illustrates the result of computing the Mahalanobis distance between the cell nucleus (group 1) and the cytoplasm (group 2) for each wave number. FIG. 9A indicates that the Mahalanobis distance is large for indices 7 and 8. FIG. 9B is a diagram in which part of learning data is plotted in a two-dimensional feature space by using, as feature values, spectral components corresponding to the indices 7 and 8. FIG. 9B indicates that the groups 1 and 2 are clearly distinguishable from each other.

FIG. 9C illustrates the result of computing the Mahalanobis distance between the cytoplasm (group 2) and the erythrocyte (group 3) for each wave number. FIG. 9C indicates that the Mahalanobis distance is large for indices 15 to 17. FIG. 9D is a diagram in which part of learning data is plotted in a two-dimensional feature space by using, as feature values, spectral components corresponding to the indices 15 and 16. FIG. 9D indicates that the groups 2 and 3 are more distinguishable than in FIG. 9B. However, the groups 1 and 2 are less distinguishable than in FIG. 9B.

In such a case, a plurality of constituents are made clearly distinguishable from each other by using all spectral components suitable for distinction between groups of each combination and projecting the suitable frequency components onto a feature space. For example, spectral components may be selected in order of decreasing Mahalanobis distance for each pair of groups, and the selected spectral components for the respective pairs may be used as machine-learning spectral components. For example, indices may be selected so as to include the indices 7 and 8 which allow clear distinction between the groups 1 and 2 and the indices 15 and 16 which allow clear distinction between the groups 2 and 3. Projection is performed in a multi-dimensional feature space by using, as feature values, spectral components corresponding to the respective indices so as to distinguish the groups.

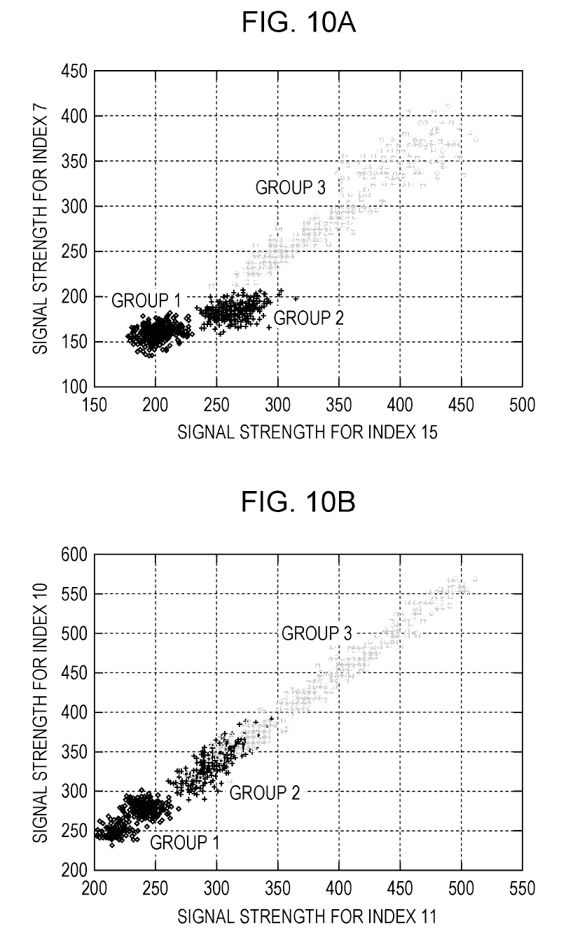

FIG. 10A is a diagram in which intensities of spectral components corresponding to indices having a large Mahalanobis distance between groups are plotted in the two-dimensional feature space. In this case, spectral components for indices 7 and 15 are selected. FIG. 10B is a diagram in which intensities of spectral components corresponding to indices having a large spectral intensity difference between groups are plotted in the two-dimensional feature space. In this case, spectral components for indices 10 and 11 are selected.

Comparison between FIG. 10A and FIG. 10B indicates that selecting spectral components having a large Mahalanobis distance makes groups more clearly separable in the feature space. That is, selecting spectral components based on the magnitude of the Mahalanobis distance enables machine learning that achieves a high classification accuracy by using less spectral components.

Spectral components were selected, classification was performed on tissue based on machine learning, and image data was reconstructed. Note that the Fisher linear discriminant analysis was used as the technique of machine learning. In addition, the image data was reconstructed using black for the cell nucleus (group 1), gray for the cytoplasm (group 2), and white for the erythrocyte (Group 3).

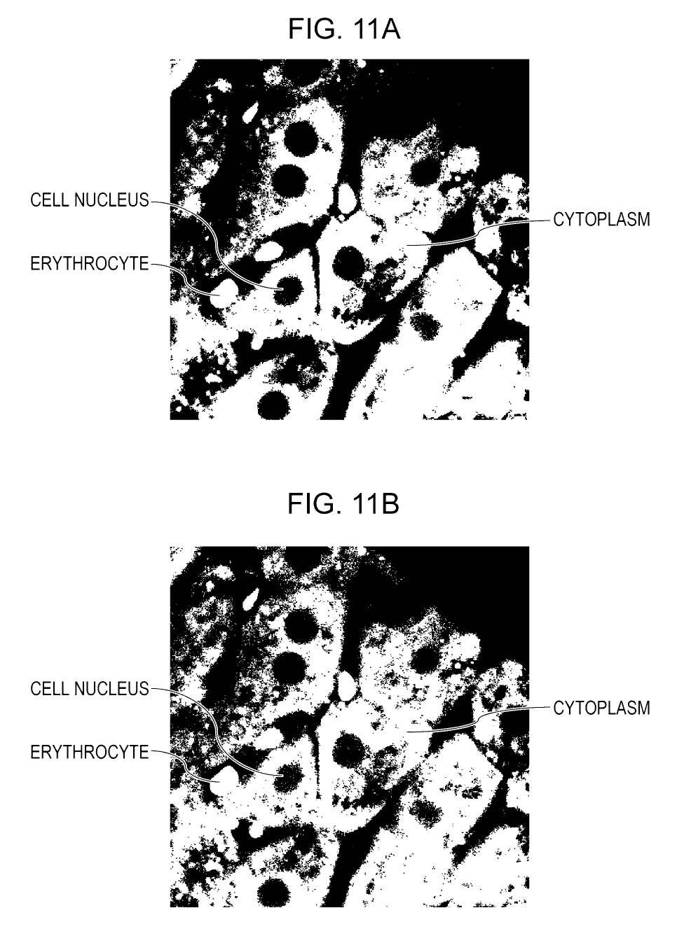

FIG. 11A illustrates an image reconstruction result obtained in the first example. This image reconstruction result is a result obtained by selecting spectral components in order of decreasing Mahalanobis distance for each pair of groups described above. In this case, 5 spectral components were selected for each pair of groups, that is, 10 spectral components were selected in total, and the cell nucleus, the cytoplasm, and the erythrocyte were distinguished.

FIG. 11B illustrates an image reconstruction result obtained in a comparative example. This image reconstruction result is a result obtained by randomly selecting spectral components from among all spectral components. In the comparative example, 10 spectral components were randomly selected from among all (90) spectral components. In addition, the process was performed in a manner similar to the first example except for the method for selecting spectral components.

In the case of performing machine learning by using all spectral components, the process took approximately 9 seconds. In contrast, the time taken for the process can be reduced to approximately 1 second by selecting 10 spectral components from all the spectral components and reducing the amount of data of the spectral data set used in machine learning. This indicates that machine learning can be done more quickly by selecting spectral components and reducing the amount of data of the spectral data set used in machine learning.

Constituents are successfully distinguished both in FIGS. 11A and 11B on the whole. However, comparison between FIGS. 11A and 11B indicates that the constituents are more clearly distinguished by using different colors in FIG. 11A, that is, in the case where spectral components are selected based on the Mahalanobis distance.

This result indicates that selecting spectral components based on the magnitude of the Mahalanobis distance and reducing the amount of data of the spectral data set used in machine learning can make machine learning quicker while maintaining the classification accuracy.

In addition, measurement may be performed at another measurement region or on another sample for 10 spectral components selected in this manner, and tissue or constituents in the sample may be classified. In such a case, performing measurement only for the 10 selected spectral components can reduce the time taken for measurement from 30 seconds to approximately 3 seconds. Performing measurement only for spectral components selected in advance can make the measurement quicker.

### Second Example

A second example of the present invention will be described below. In the second example described below, the same or substantially the same measuring device 2 and the same or substantially the same measurement conditions as those used in the first example were used.

FIG. 13 is a diagram in which recomputed data obtained by performing an averaging process on a spectral component of the index 15 and its adjacent spectral components among the data illustrated in FIG. 10A is plotted similarly to FIG. 10A. Comparison between FIG. 13 and FIG. 10A indicates that the within-group variance of the groups 1 and 2 are reduced in the horizontal direction in the second example.

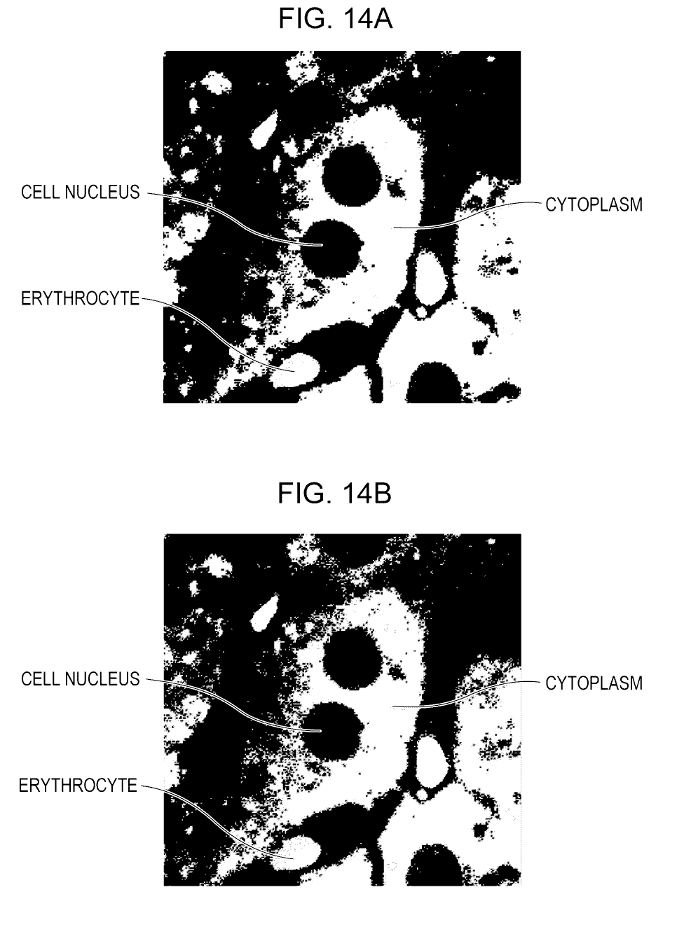

FIG. 14A illustrates an enlarged view of a part of an image reconstruction result obtained in the second example. In the second example, the cell nucleus, the cytoplasm, and the erythrocyte were distinguished by using two spectral components for the indices 7 and 15. FIG. 14B illustrates an enlarged view of a part of the image reconstruction result obtained in the first example as a reference. Comparison between FIG. 14A and FIG. 14B indicates that the second example provides a reconstructed image with a clearer outline of each target to be distinguished as is apparent from the outline of the cell nucleus at the central part of the image, for example. That is, according to the second example, a classifier having a higher classification accuracy can be generated by the averaging process.

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-140908, filed Jul. 8, 2014, which is hereby incorporated by reference herein in its entirety.

1. A data processing apparatus that processes a spectral data item which stores, for each of a plurality of spectral components, an intensity value, comprising:
a spectral component selecting unit configured to select, based on a Mahalanobis distance between groups each composed of a plurality of spectral data items or a spectral shape difference between groups each composed of a plurality of spectral data items, a plurality of machine-learning spectral components from among the plurality of spectral components of the plurality of spectral data items; and
a classifier generating unit configured to perform machine learning by using the plurality of machine-learning spectral components selected by the spectral component selecting unit and generate a classifier that classifies a spectral data item.

2. The data processing apparatus according to claim 1, wherein the spectral component selecting unit selects the plurality of machine-learning spectral components in order of decreasing Mahalanobis distance.

3. The data processing apparatus according to claim 1, wherein the spectral component selecting unit selects the machine-learning spectral components in order of decreasing Mahalanobis distance separately for each of a plurality of combinations of the groups to be distinguished by the classifier.

4. The data processing apparatus according to claim 1, wherein the spectral component selecting unit selects the plurality of machine-learning spectral components finely at a part where the Mahalanobis distance is large and coarsely at a part where the Mahalanobis distance is small.

5. (canceled)

6. The data processing apparatus according to claim 1, wherein the spectral data items are spectral data items stored for respective pixels in image data.

7. The data processing apparatus according to claim 1, wherein the classifier generating unit performs, for each of the plurality of machine-learning spectral components, an intensity value averaging process in accordance with magnitude of a within-group variance of the plurality of spectral data items and performs machine learning.

8. The data processing apparatus according to claim 1, wherein the spectral data items are spectral data items including any one of spectral data items obtained by ultraviolet, visible, or infrared spectroscopy, spectral data items obtained by Raman spectroscopy, and mass spectral data items.

9. The data processing apparatus according to claim 1, wherein the spectral components are represented by a wave number or a mass-to-charge ratio.

10. The data processing apparatus according to claim 1, further comprising:
a classifying unit configured to classify a spectral data item by using the classifier generated by the classifier generating unit.

11. The data processing apparatus according to claim 10, wherein two-dimensional image data is generated based on a classification result obtained by the classifying unit, the two-dimensional image data being data for distinguishably displaying pixels for which respective spectral data items are stored.

12-13. (canceled)

14. A sample information obtaining system comprising:
the data processing apparatus according to claim 1; and
a measuring unit configured to perform measurement on a sample to obtain the spectral data items.

15. The sample information obtaining system according to claim 14, wherein the measuring unit performs measurement on the basis of the machine-learning spectral components selected by the spectral component selecting unit to obtain the spectral data items.

16. A data processing method for processing a spectral data item which stores, for each of a plurality of spectral components, an intensity value, comprising:
selecting, based on a Mahalanobis distance between groups each composed of a plurality of spectral data items or a spectral shape difference between groups each composed of a plurality of spectral data items, a plurality of machine-learning spectral components from among the plurality of spectral components of the plurality of spectral data items; and
performing machine learning by using the plurality of machine-learning spectral components selected in the selecting, and generating a classifier that classifies a spectral data item.

17. The data processing method according to claim 16, further comprising:
classifying a spectral data item by using the generated classifier.

18. (canceled)

19. A computer-readable storage medium storing a program causing a computer to execute a process, the process comprising:
selecting, based on a Mahalanobis distance between groups each composed of a plurality of spectral data items or a spectral shape difference between groups each composed of a plurality of spectral data items, a plurality of machine-learning spectral components from among a plurality of spectral components of the plurality of spectral data items each storing, for each of the plurality of spectral components, an intensity value; and
performing machine learning by using the plurality of machine-learning spectral components selected in the selecting and generating a classifier that classifies a spectral data item.
